(19) United States
(12) Patent Application Publication
(10) Pub. No.: US 2010/0328236 A1
(43) Pub. Date: Dec. 30, 2010

(54) Method for Controlling a Computer System and Related Computer System

(76) Inventor: Hsin-Hua Ma, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/684,963

(22) Filed: Jan. 10, 2010

(30) Foreign Application Priority Data
Jun. 29, 2009 (TW) 098121812

(51) Int. Cl. G06F 3/041

(52) U.S. Cl. 345/173

(57) ABSTRACT

A method for controlling a computer system is disclosed. The computer system includes a touch device, a control module, a display device and an operation module. The touch device includes a main touch area without display function, wherein a touch point is moved for moving a cursor displayed in the display device. The main touch area includes a first partition and a second partition. The method includes the control module receiving an enable signal, a first touch point of the main touch area being touched, the touch device outputting a first touch signal to the control module, the control module deciding whether the first touch point is inside the first partition according to the first touch signal, and the control module notifying the operation module to perform a first program if the first touch point is inside the first partition.

### BACKGROUND OF THE INVENTION

1. Field of the Invention

The present invention relates to a method for controlling a computer system and related computer system, and more particularly, to a method for enhancing utilization convenience of a computer system and related computer system.

2. Description of the Prior Art

Graphical user interface is an easy-to-use computer operating interface, which displays graphics of windows, icons, buttons, etc, in a frame, such that a user can select graphics through a pointing device for executing operations with different purposes. In the prior art, except to a mouse, a touch pad is a pointing device mostly utilized in a computer system, especially a notebook, because the touch pad can be installed in the notebook for benefiting a realization of portability. In addition, lifetime of the touch pad is longer than a conventional key, and the touch pad has less mechanical fatigue appearing than the conventional key. Besides the conventional touch pad, current notebook is usually equipped with a second touch pad for controlling audio and video playing, which has LED backlight for displaying positions and functions of touch keys of the second touch pad. In addition, PDA, or UMPC uses a touch panel with display functions as an input device.

The operation principle of the touch pad has been disclosed in many technical documents. For example, the second version of TouchPad Interfacing Guide 510-000080-A published by Synaptics discloses basic operation principle and characteristic of the touch pad, and divides operation modes of the touch pad into a relative mode and an absolute mode. Please refer to FIG. 8, which shows the FIG. 2-19 of TouchPad Interfacing Guide 510-000080-A, where a process in the left of FIG. 8 represents the relative mode, and the other process in the right of FIG. 8 represents the absolute mode. In the relative mode, the touch pad reports a variance of relative positions to a driving program, for moving a cursor. For the system, the touch pad is equivalent to a mouse. In the absolute mode, the touch pad reports position time and strength of a finger touch (or other objects) to the driving program to calculate displacement (which includes data of distance, time, etc) of a touch point. The touch pad driving program after Microsoft Windows 95 usually uses the absolute mode. That is, the driving program controls cursor movement by converting received touch position data, and provides more functions, such as multi-point touch, drag, window scroll, etc. TouchPad Interfacing Guide 510-000080-A only discloses the operation mode and method of the touch pad, but basically the touch pad disclosed in TouchPad Interfacing Guide 510-000080-A still simulates functions of a mouse.

Touch pad has many advantages, but the operation of the touch pad is still followed the mouse. Take Microsoft Windows as an example. If a shortcut of a program desired to be executed is not shown in the desktop, there are two operating methods for the touch pad to execute the program. The first method includes: clicking “Start”, then “All programs”, and finally clicking the shortcut of the program. The second method includes: selecting “My computer”, entering a disk with the program installed, and finally clicking executable file of the program.

As can be seen, via the touch pad, the user executes the program through complicated steps no matter which operating method is used. In addition, even though the shortcut of the program has been placed in the desktop, the user still needs to move the cursor for clicking and executing the program. Therefore, for improving the operating method of the conventional touch pad, the prior art has provided many improving methods.

For example, U.S. Pat. No. 6,037,930 discloses a multimodal touch sensitive peripheral device, which is operated in multiple operation modes, such as a mouse mode (namely the abovementioned relative mode), an absolute mode, a joystick mode, and a numeric keypad mode. The mouse mode and the absolute mode is equivalent to the relative mode and the absolute mode of TouchPad Interfacing Guide 510-000080-A, and the joystick mode is an operation of corresponding the touch pad to eight directions for simulating direction keys of a joystick. In addition, the numeric keypad mode is an extension of the absolute mode, which divides the touch pad into a plurality of areas each corresponding to a number or mathematical operation function (e.g. add, subtract, multiply, divide, etc), for simulating a numeric keypad. The numeric keypad mode is usually utilized in a notebook without numeric keypad installation. Therefore, in order to enhance utilization convenience, the touch pad is used to simulate a numeric keypad. In the numeric keypad mode, the multimodal touch sensitive peripheral device disclosed in the U.S. Pat. No. 6,037,930 converts a coordinate of a finger touch (or other object) into a corresponding number or operation function (please refer to step 4 of FIG. 14 of the US patent, where the joystick mode should be an error of the numeric keypad mode). In other words, the numeric keypad mode simply converts the coordinate of the finger touching into a key value of the number or the operation symbol, namely American Standard Code for Information Interchange (ASCII). Besides, the U.S. Pat. No. 6,037,930 does not clear specify how the numeric keypad mode is applied for triggering a program or function of the computer system.

Taiwan patent publication No. 200707165 discloses an electric device with trace identification mode and keypad identification mode, which can be operated in a trace identification mode and a keypad identification mode. The trace identification mode is used for identifying a moving trace of a finger, namely the relative mode of TouchPad Interfacing Guide 510-000080-A. The keypad identification mode is similar to the numeric keypad mode of the U.S. Pat. No. 6,037,930, which divides the touch pad into a plurality of areas each corresponding to a key of the keypad. Similarly, this Taiwan patent application does not clear specify how the keypad identification mode is applied for triggering the program or function of the computer system.

U.S. Pat. No. 7,324,082 discloses a portable data processing device with one touch control and switching method thereof, which is not only operated in the relative mode of TouchPad Interfacing Guide 510-000080-A, but also switched to another operation mode when a switch signal is received. In this operation mode, a display module included in the touch pad displays touch input keys and corresponding application programs or functions (please refer to FIG. 4 and corresponding description of this US patent) for the user to directly touch the display module. When one of the touch input keys pressed by the user is detected, the system executes the corresponding application program or function. In other words, in the U.S. Pat. No. 7,324,082, the touch pad uses a touch screen with a display function for triggering the program or function of the computer system, which increases the cost of manufacturing, and cannot be applied in the notebook.

U.S. Pat. No. 6,559,833 discloses an apparatus and method for achieving absolute and relative positioning of a graphics cursor, which executes the relative or absolute positioning according to a position of a user touch or a moving direction. Therefore, the apparatus and method of the US patent only concerns an activation of the absolute mode or the relative mode, but not the activation of the program or function of the computer system.

U.S. Pat. No. 6,757,002 discloses a track pad pointing device with areas of specialized function, which increases a plurality of dedicated areas around a surface of the touch pad for triggering a particular program of function. That is, those dedicated areas are only used for triggering a predetermined program or function, which is similar to the operation of the keypad. Please refer to a flowchart of FIG. 13 of U.S. Pat. No. 6,757,002. The system determines whether a touch area is inside a main detecting area, and performs a general action (e.g. a mouse function) if the touch area is inside the main detecting area. In this situation, the touch pad requires additional space for the dedicated areas, which increases the manufacturing cost.

### SUMMARY OF THE INVENTION

Therefore, the present invention provides a method and related computer system for controlling a computer system.

The present invention discloses a method for controlling a computer system comprising a touch device for detecting a touch action and outputting a touch signal, a control module for receiving the touch signal, a display device, and an operation module for performing programs. The touch device comprises a main touch area without display function, wherein a touch point is moved for moving a cursor displayed in the display device, and the main touch area comprises a first partition and a second partition. The method comprises the following steps: the control module receiving an enable signal, a first touch point of the main touch area being touched, the touch device outputting a first touch signal to the control module, the control module deciding whether the first touch point is inside the first partition according to the first touch signal, and the control module notifying the operation module to perform a first program if the first touch point is inside the first partition.

The present invention further discloses a method for controlling a computer system comprising a pointing device for detecting a direction action and outputting a direction signal, a control module for receiving the direction signal, a display device, and an operation module for performing programs. The control module moves a cursor displayed in the display device according to the direction signal, and the pointing device is capable of detecting areas of a first direction area and a second direction area. The method comprises the following steps: the control module receiving an enable signal, the pointing device detecting a first direction action, the pointing device outputting a first direction signal to the control module, the control module deciding whether the first direction action is inside the first direction area according to the first direction signal, and the control module notifying the operation module to perform a first program if the first direction area is inside the first direction area.

The present invention further discloses a computer system. The computer system comprises a display device, a touch device for detecting a touch action and outputting a touch signal, the touch device comprising a main touch area without display function, wherein a touch point is moved for moving a cursor displayed in the display device, and the main touch area comprises a first partition and a second partition, a control module for receiving the touch signal, the control module being switched between a common mode and a quick start mode, wherein in the common mode, the control module calculates a displacement data of the touch point after the touch signal is received, and thereby controls the movement of the cursor according to the displacement data, and an operation module for performing programs, wherein the control module is switched to the quick start mode after an enable signal is received, the touch device detects a first touch point of the main touch area being touched, and outputs a first touch signal to the control module, the control module decides which partition the first touch point occurs according to the first touch signal, and notifies the operation module to perform a first program if the first touch point is inside the first partition.

The present invention further discloses a computer system comprising a pointing device for detecting a direction action and outputting a direction signal, a control module for receiving the direction signal, a display device and an operation module for performing programs, wherein the control module moves a cursor displayed in the display device according to the direction signal, and the pointing device is capable of detecting areas of a first direction area and a second direction area. The computer system comprises the control module receiving an enable signal, the pointing device detecting a first direction action, the pointing device outputting a first direction signal to the control module, the control module deciding whether the first direction action is inside the first direction area according to the first direction signal, and the control module notifying the operation module to perform a first program if the first direction area is inside the first direction area.

The present invention further discloses a method for controlling a computer system comprising a touch pad. The method comprises corresponding a plurality of areas of the touch pad to a plurality of programs of the computer system according to an enable signal, detecting a touch signal from the touch pad, and triggering a program of the plurality of programs according to a position of the touch signal included in an area corresponding to the program.

The present invention further discloses a computer system capable of instantly triggering programs. The computer system comprises an operation module for realizing functions of the computer system, a touch pad, and a control device which is coupled to the operation module and the touch pad, and comprises an activation unit for corresponding a plurality of areas of the touch pad to a plurality of programs of the operation module according to an enable signal, and an execution unit for triggering a program of the plurality of programs according to a position of a touch signal included in an area corresponding to the program when the touch signal from the touch pad is detected.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a control process according to an embodiment of the present invention.

FIG. 2A is a schematic diagram of a computer system according to an embodiment of the present invention.

FIG. 2B is a functional block diagram of a computer system of FIG. 2A.

FIG. 3 is a schematic diagram of areas of a touch pad of FIG. 2A.

FIGS. 4A and 4B are schematic diagrams of a screen of FIG. 2A.

FIG. 4C, 4D, 5 and 6 are schematic diagrams of exemplary embodiments of FIG. 2A.

FIGS. 7A and 7B are functional block diagrams of a computer system of FIG. 2A.

FIG. 8 is FIGS. 2-19 of TouchPad Interfacing Guide 510-000080-A.

### DETAILED DESCRIPTION

According to a computer system of the present invention, a user can select mostly used application programs in advance and schemes different areas on a touch pad, to correspond each selected application program to an area of the touch pad. In a common mode, the operating method and functionality of the touch pad is similar to a conventional mouse. That is, those pre-selected application programs are not triggered when the user touches the touch pad. The system switches operation of the touch pad to a special mode (hereafter called quick start mode), and performs the following steps.

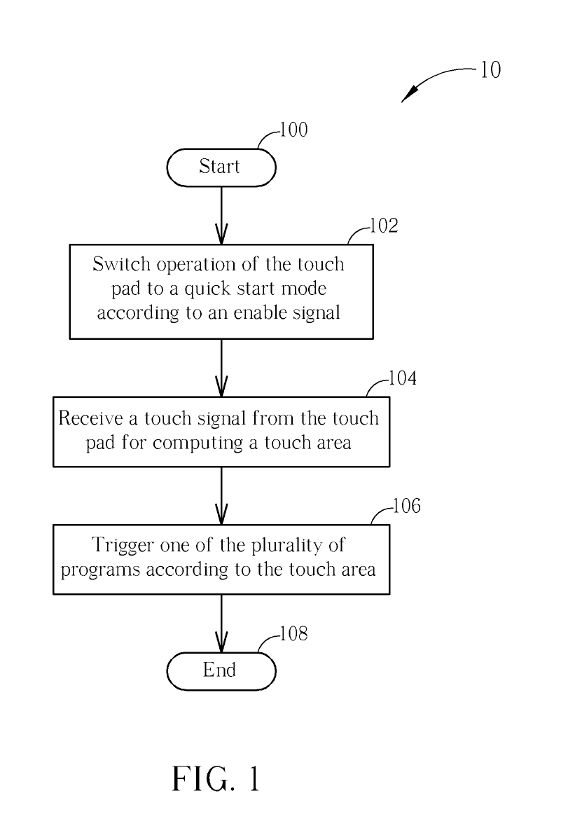

Please refer to FIG. 1, which is a schematic diagram of a control process 10 according to an embodiment of the present invention. The control process 10 is utilized in a computer system with a touch pad, and includes the following steps:

Step 100: Start.

Step 102: Switch operation of the touch pad to a quick start mode according to an enable signal.

Step 104: Receive a touch signal from the touch pad for computing a touch area.

Step 106: Trigger one of the plurality of programs according to the touch area.

Step 108: End.

According to the control process 10, the system switches the operation of the touch pad from the common mode to the quick start mode when an enable signal is received, in which the mode switch can be realized by executing a control program. In addition, a common control program code and a quick start program code can be included in a driving program, and the enable signal results in a value change of a register (e.g. from 0 to 1). The driving program executes the common control program code when the value of the register is 0; meanwhile, the operation of the touch pad is in the common mode. The driving program executes the quick start program code when the value of the register is 1. Meanwhile, the operation of the touch pad is in the quick start mode.

In the quick start mode, when the user touches the touch pad, the system receives the touch signal including information of a touch position. Since the touch pad has been divided into the plurality of areas each corresponding to a program, the system decides which area a touch point is inside according to a position of the touch signal for triggering a program corresponding to the area. Therefore, the user does not enter a menu layer by layer, and just needs to touch a certain area of the touch pad for triggering the corresponding program through the quick start mode of the present invention.

In the control process 10, the enable signal is used for switching the touch pad from the common operation mode to the quick start mode. In the common operation mode, the operation of the touch pad is used for detecting a moving direction, strength, etc, of the user touch, to output a corresponding control signal to a host of the computer system. The touch pad is switched to the quick start mode when the enable signal is received, and instantly triggers the corresponding function according to the position of user touch. Note that, the enable signal is only used for switching the operation mode of the touch pad, whose signal content, format, generating method, etc, are not limited in any certain technique, and those skilled in the art can design an enable signal meet the need. For example, the enable signal can be generated by pressing a key or simultaneously pressing a plurality of keys, or is generated by software. In addition, the quick start mode can be automatically executed after the computer system is booted. That is, the enable signal is generated by a boot program of the computer system.

Besides the enable signal, the present invention can generate a disable signal through a key, software, etc, for stopping the quick start mode, so as to get the touch pad back to the common operation mode. In addition, the program corresponding to each area of the touch pad can be preset by a manufacturer and/or the user. For example, the user sets the program desired to be instantly triggered according to a user's habit. On the other hand, the present invention can display a graphical interface in a screen of the computer system when the quick start mode is activated, to indicate a relationship between each area of the touch pad and the program. Therefore, the user can clearly know which area should be touched, for enhancing the utilization convenience.

In addition, step 106 triggers the corresponding program according to the position of the touch signal. Based on this concept, the program can be triggered according to the finger movement (e.g. sliding direction or vector) calculated from the touch signal, and the related modification is also in the scope of the present invention. In this case, the selected application programs are preset to correspond different finger movements (e.g. up, down, left, right, etc) respectively for triggering the application programs. The following steps are used for detecting a movement for performing the quick start mode.

Step 0: Start.

Step 2: Switch operation of the touch pad to the quick start mode according to an enable signal.

Step 4: Receive the touch signal from the touch pad and calculate a move of touch position.

Step 6: Trigger one of the plurality of programs according to the move of touch position.

Step 8: End.

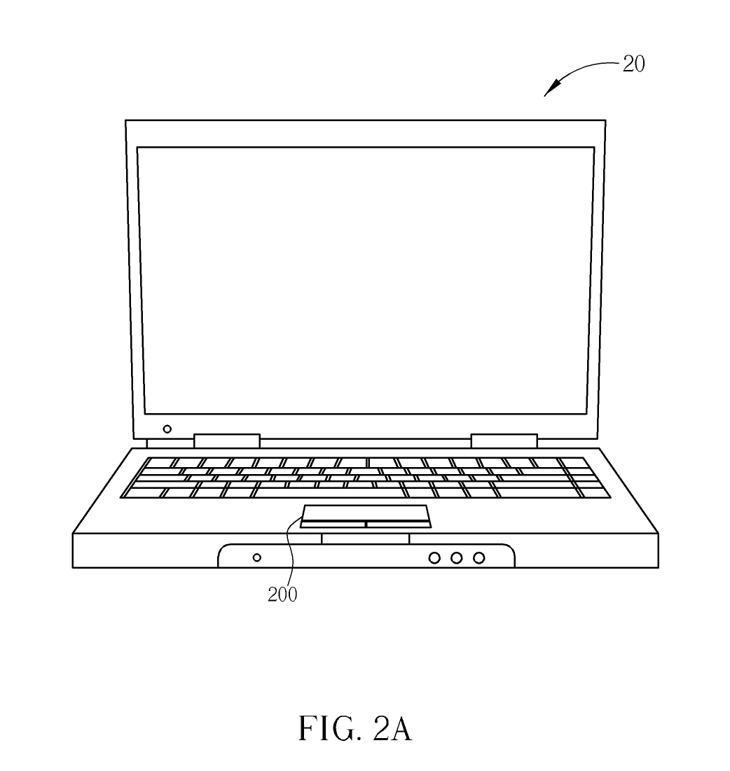

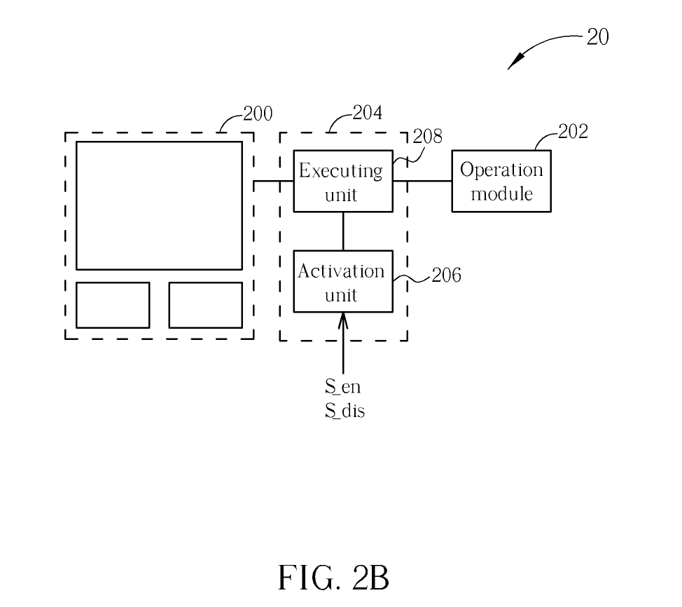

As can be seen, in the quick start mode, the user only touches an area of the touch pad, and then the program corresponding to the area is triggered, so as to enhancing the utilization convenience. As to a realization of the control process 10, please refer to FIGS. 2A and 2B. FIG. 2A is a schematic diagram of a computer system 20 according to an embodiment of the present invention, and FIG. 2B is a functional block diagram of the computer system 20. As can be seen in FIG. 2A, the computer system 20 is a notebook, which has a touch pad 200. For clearly illustrating the concept of the present invention, the computer system 20 is simplified to be composed of the touch pad 200, an operation module 202, and a control device 204. The operation module 202 is used for realizing the function of the computer system 20, which comprises a CPU, memory, and other input/output device, and is well-known for those skilled in the art, so the detail description is omitted herein. The control device 204 is used for realizing the control process 10, and includes an activation unit 206 and an executing unit 208. The activation unit 206 can switch the touch pad 200 from the common operation mode to the quick start mode when an enable signal S_en is received, and switch the touch pad 200 from the quick start mode to the common operation mode when a disable signal S_dis is received. In the embodiment of the present invention, the common operation mode can be realized via a common operation program code executed by the activation unit 206, and the quick start mode can be realized via a quick start program code executed by the activation unit 206. The executing unit 208 in the quick start mode triggers the corresponding program according to the position of the touch signal on the touch pad 200. The detailed operation method can be referred as following.

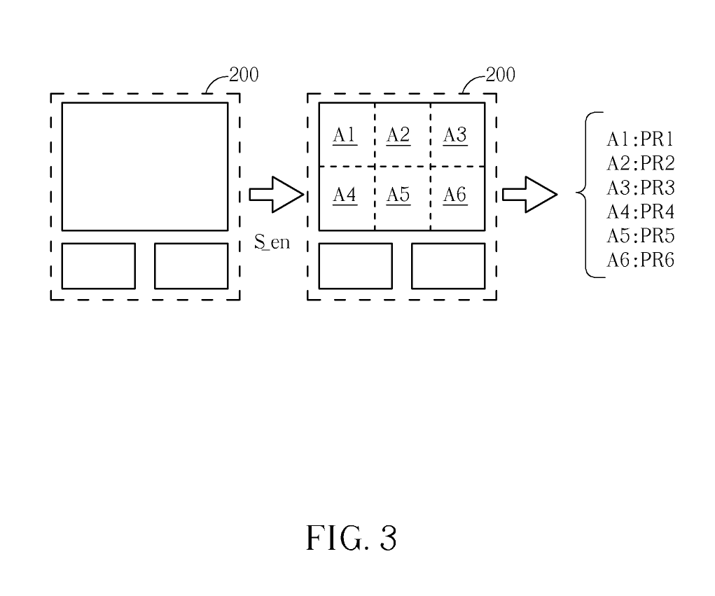

In FIG. 3, when the activation unit 206 receives the enable signal S_en, the activation unit 206 switches the operation of the touch pad 200 to the quick start mode. Meanwhile, a touch screen of the touch pad 200 is divided into areas A1-A6 corresponding to programs PR1-PR6 according to the preset data. Please note that, division of the areas A1-A6 is an example. In practice, the touch pad 200 can be divided into any amount of areas and is not limited herein. If the user touches any of the areas, the execution unit 208 triggers the corresponding program. For example, if the area A2 is touched, the program PR2 is executed thereof.

In addition, although the present invention takes the activation unit 206 and the execution unit 208 as a functional description; in practice, these two units can be constituted by different hardware, or realized via different program codes executed by a microprocessor. Similarly, because the operating rate and function of the microprocessor are gradually increased, operation of part of the touch pad 200 can also use the same microprocessor with the activation unit 206 and the execution unit 208. Also, the operation module 202 uses the same processor with the execution unit 208.

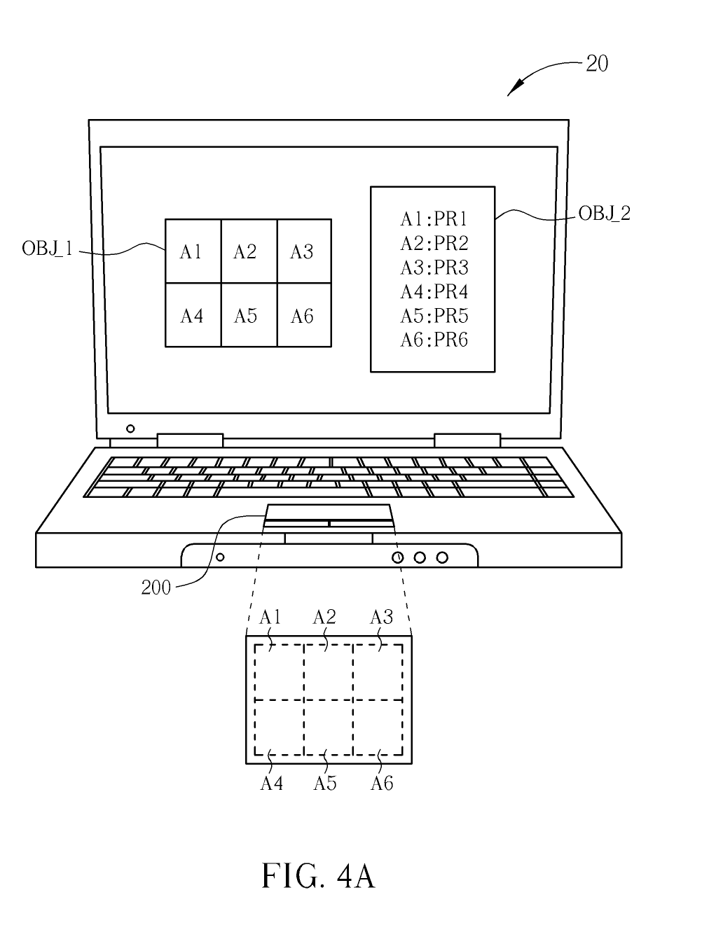

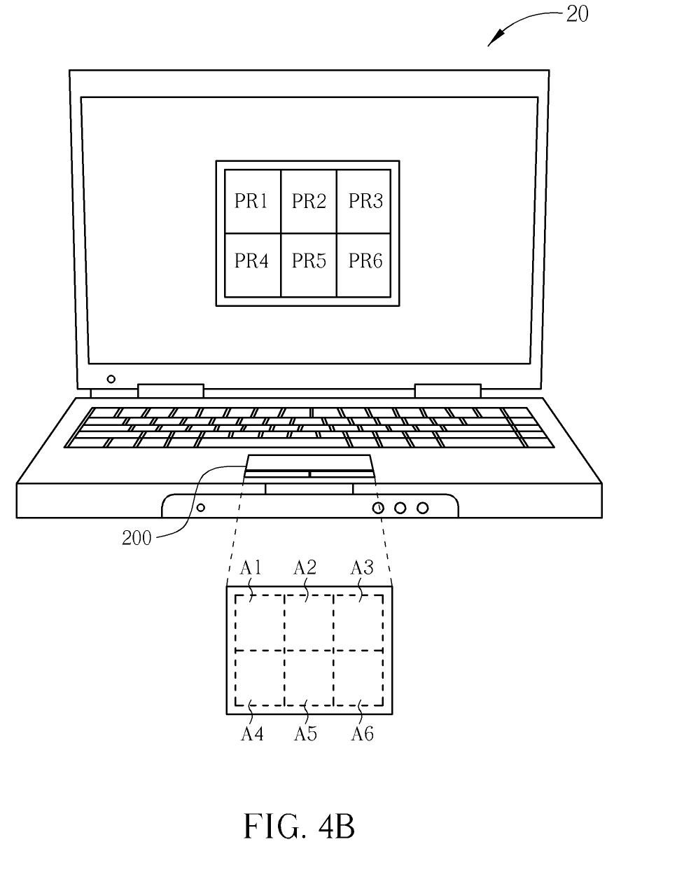

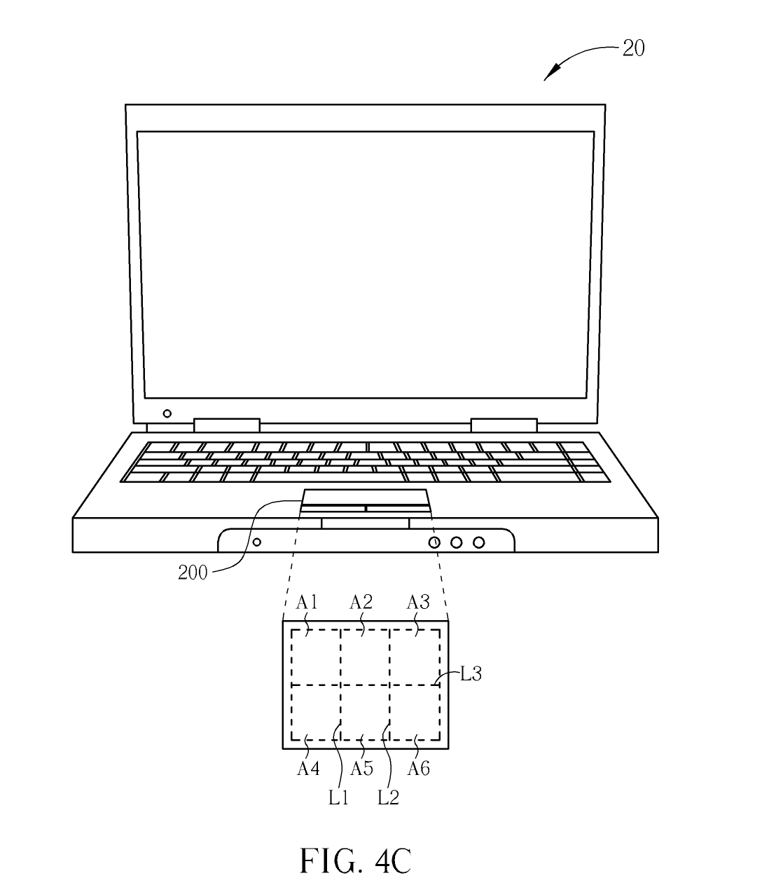

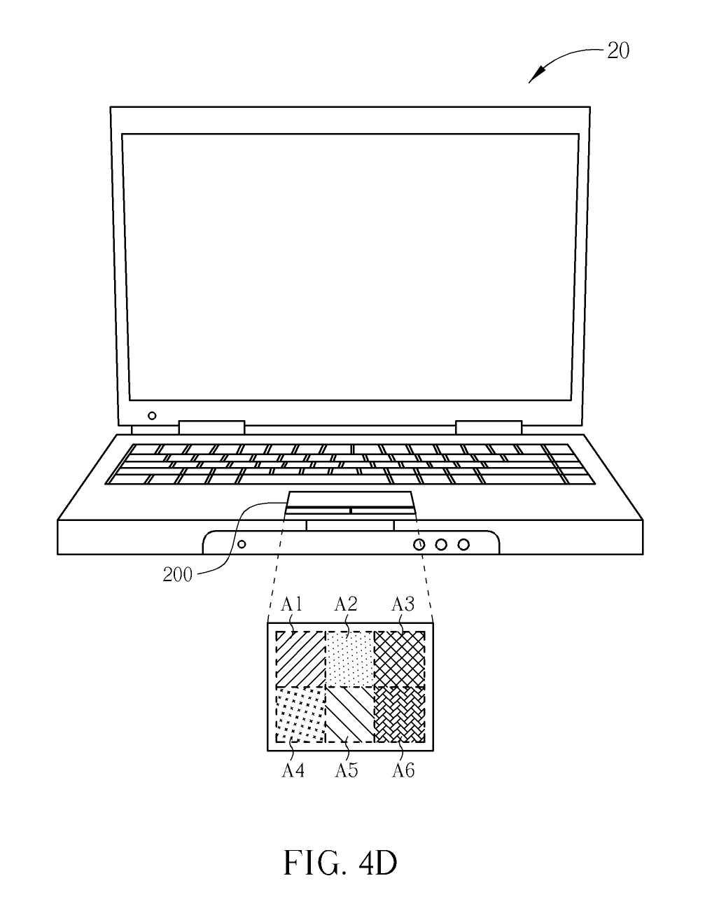

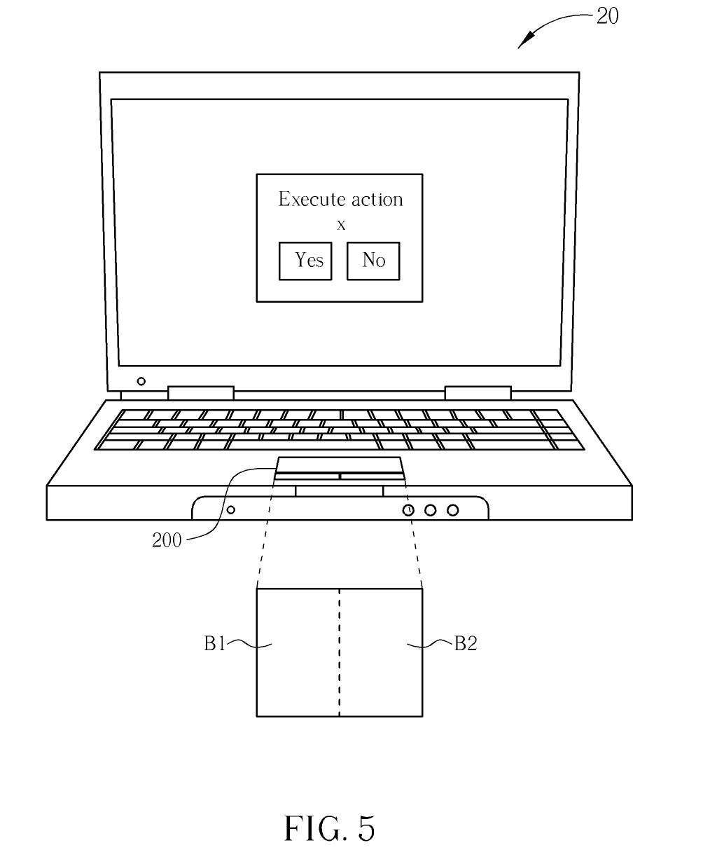

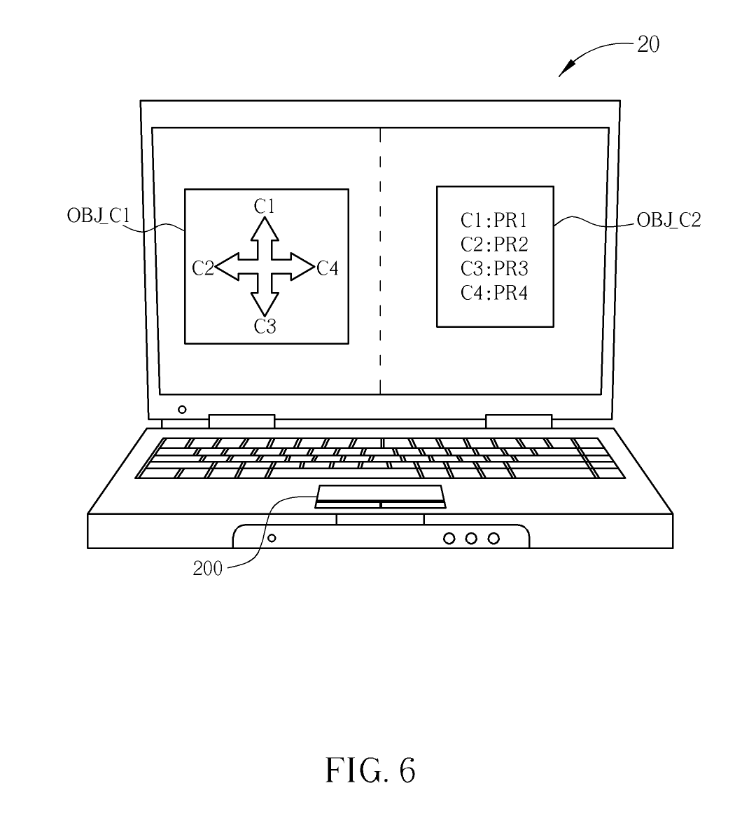

In addition, when the touch pad 200 is operated in the quick start mode, the screen of the computer system 20 can display a graphical interface for indicating the program corresponding to each area. For example, in FIG. 4A, the screen of the computer system 20 displays graphics OBL_1 and OBJ_2. The graphic OBL_1 is used for displaying area state of the touch pad 200, and the graphic OBL_2 is used for displaying programs corresponding to areas respectively. In FIG. 4B, the screen of the computer system 20 directly displays the programs corresponding to areas of the touch pad 200 respectively. The user can clearly know the programs corresponding to the areas A1-A6 through FIG. 4A or 4B, for enhancing the utilization convenience. Certainly, the method of displaying programs each corresponding to an area is not limited in the embodiments of FIG. 4A or FIG. 4B, and those skilled in the art can design a proper display method accordingly. In addition, the touch pad 200 can be distributed visual indicators, such as lines, color coatings, symbols, LED backlight graphics, etc, for distinguishing position of each area. For example, in FIG. 4C, the touch pad 200 is coated with lines L1, L2, and L3 for distinguishing positions of the areas A1-A6 for preventing an incorrect user touch. Similarly, in FIG. 4D, different geometric graphics indicate different colors, namely areas of the touch pad 200 are coated with different colors respectively. Note that, embodiments shown in FIGS. 4C and 4D are used for distinguishing a range of each area and can be utilized in FIGS. 4A and 4B, which is not limited herein.

In addition, contents of the programs PR1-PR6 are not limited in a certain type. Preferably, each area is preset to correspond to a program or function via the manufacturer, or can be set through a setting unit (not shown in FIG. 2B) by the user. During the setting, the system displays a setting interface, so the user can complete the setting through manual input (input an address of an execution file) or drag method (drag a shortcut or an address of an execution program in a field of the setting interface).

In addition, if the amount of the programs desired to be quickly started is more than six, one of the programs PR1-PR6 is used for indicating “Next page” for entering a menu in another page, and thereby the menu of PR7-PR12 is displayed. The detailed description can be referred from above, so it is not given herein. If the quick start mode is activated after the computer system is booted, one of the programs PR1-PR6 is used for indicating “Close”. When the user touches an area represented “close” of the touch pad, a disable signal is sent out.

The abovementioned embodiments are only used for illustrating the concept of the present invention, and those skilled in the art can make alternations and modifications accordingly. For example, the enable signal S_en can be generated by a key, software or a boot program, and the disable signal S_dis can be generated in the same manner, or the system automatically inactivates the quick start mode after the application program is triggered according to the touch signal.

In addition, if the enable signal S_en is generated by certain software, the amount of the areas or the program of each area can be varied as needed. For example, in FIG. 5, when the computer system 20 asks the user to indicate whether an action x, such as deleting file, shutdown, etc, is executed, the enable signal S_en is generated for dividing the touch pad 200 into left and right areas B1 and B2 corresponding to “Yes” and “No” respectively. In this situation, the user only needs to touch the area B1 to execute “Yes”, or touch the area B2 to execute “No”. Moreover, in order to avoid the user unfamiliar with such operating method, the present invention sets the system to use the operating method of the quick start mode shown in FIG. 5 when the user touches the touch pad 200 in a way of click. In other words, when the user touches the touch pad 200 in a sliding way, the system regards the sliding operation as the disable signal S_dis, and is returned to the common operation mode. Then, the cursor is moved according to the trace of the sliding operation. The basis of determining whether the user uses clicking or sliding method is according to time of a finger stayed at a point or at the touch pad 200, or to a moving distance. In addition, if the cursor is just at the bottom of the graphical interface (namely “Yes” and “No”), the single click or double click can be used for determining whether the user wants to press the bottom or use the operating method shown in FIG. 5.

In the abovementioned embodiments, the control device 204 triggers the corresponding program according to the position that the user touches at the touch pad 200. In another embodiment, the corresponding program can be triggered according to a moving direction of the touch signal. For example, in FIG. 6, graphics OBL_C1 and OBJ_C2 is displayed in the screen of computer system 20, in which the graphic OBL_C1 displays directions C1, C2, C3 and C4 of the touch pad 200, and the graphic OBL_C1 displays the programs PR1, PR2, PR3, and PR4 corresponding to the directions C1, C2, C3 and C4 respectively. In this situation, if the user's finger slides along the direction C1 on the touch pad 200, the program PR1 is triggered. In addition, a pointing stick of IBM for controlling the cursor is well-know for those skilled in the art, so the embodiment of FIG. 6 can be utilized in the pointing stick of IBM. That is, when the user pushes the pointing stick to the direction C1, the program PR1 is triggered.

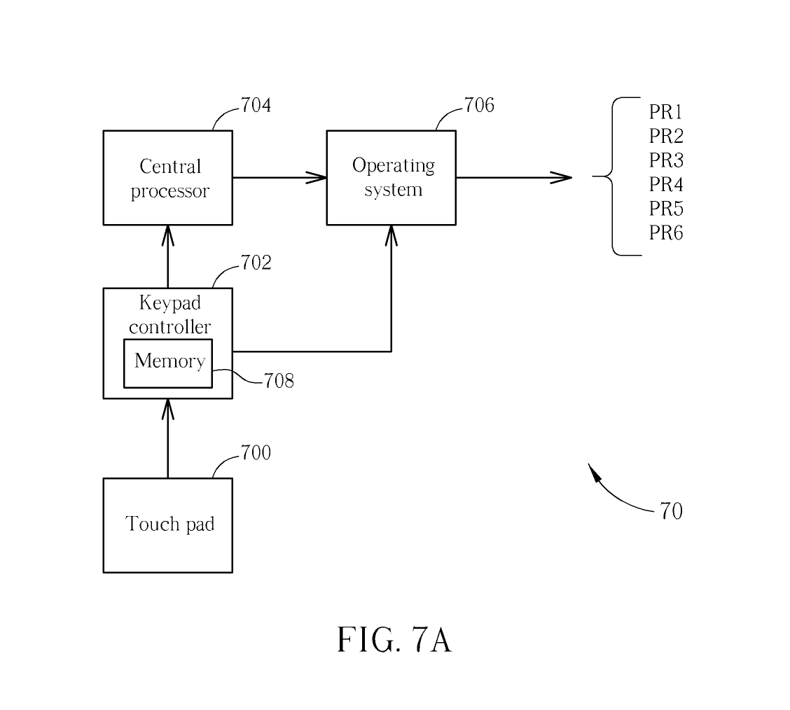

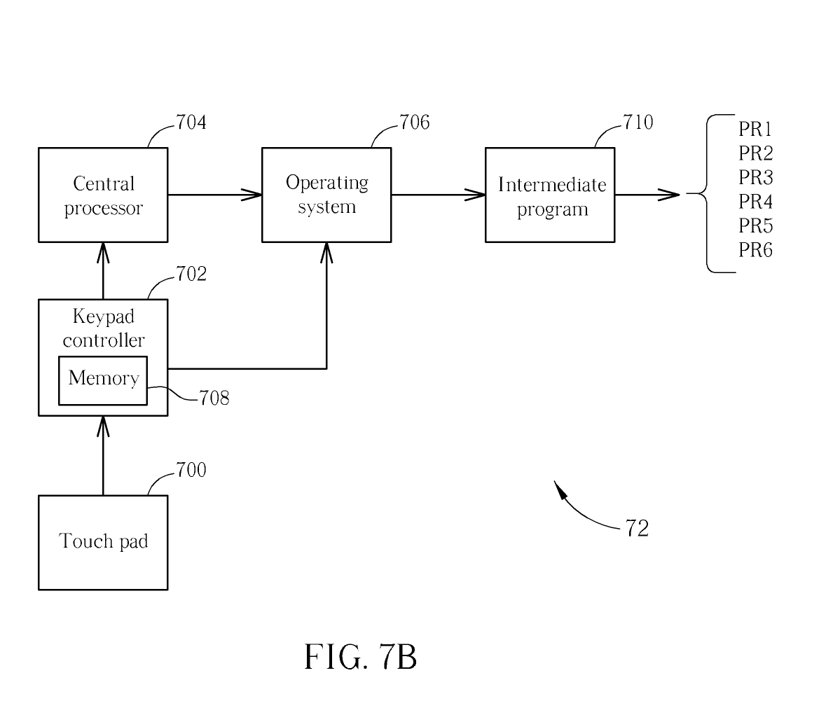

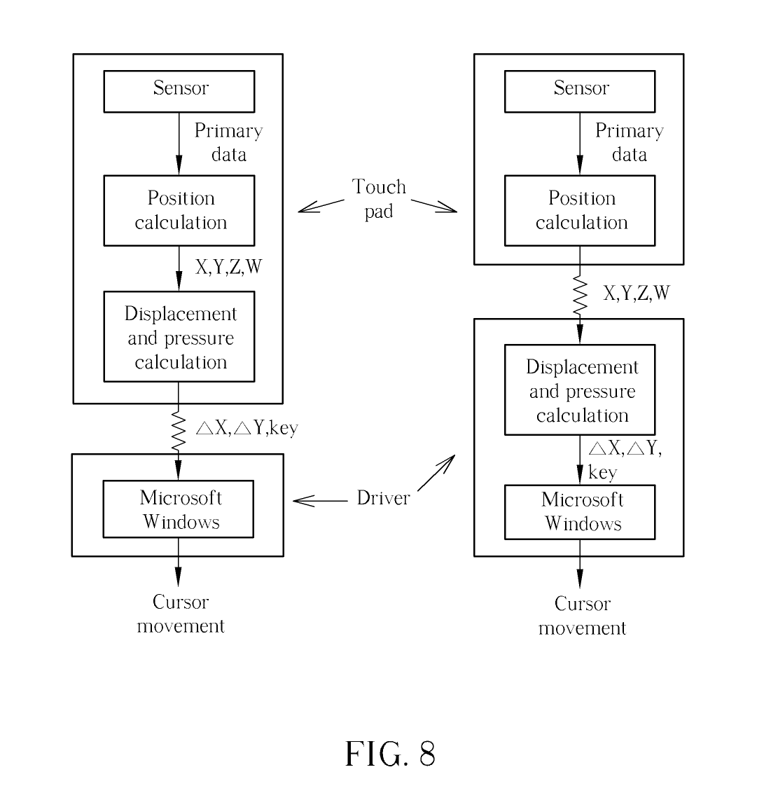

Please refer to FIG. 7A, which is a functional block diagram of a computer system 70. FIG. 7A briefly presents partial components related to operation of touch for illustrating the method of realizing the control device 204. Firstly, in the common operation mode, when the user touches a touch pad 700, the touch pad 700 generates a corresponding touch signal, such as (x, y, z, t) according to a position, strength, and time of touch. A keypad controller 702 stores data of the touch signal of the touch pad 700 in a memory 708, and outputs an interrupt signal to a central processor 704 for notifying the central processor 704 of a touch event. Then, the central processor 704 notifies an operating system 706 to read the data stored in the memory 708 for generating a corresponding operation needed by the user. The abovementioned operating methods are not only utilized in the touch pad, but also the mouse, keypad, joystick, etc. According to the quick start functionality of the present invention, the execution unit 208 can be realized by modifying the keypad controller 702 or operating system 706. For the detailed description, please refer to the following examples.

### Example A

After the user sets the computer system 70 in the quick start mode through a certain bottom, software, boot program, etc, the keypad controller 702 converts the touch signal of the user into a specific command for notifying the operating system 706 to execute a corresponding application program. That is, in this example, after the computer system 70 is operated in the quick start mode, the touch pad 700 is divided into a plurality of areas each corresponding to an application program. If the user touches one of the plurality of areas, the touch pad 700 transmits a touch signal of the touch point to the keypad controller 702 to determine which area the touch point is inside for generating command data, and store the data in the memory 708. Then, the keypad controller 702 outputs an interrupt signal to the central processor 704 for notifying the processor 704 of a touch event. The central processor 704 then notifies the operating system 706 to read data stored in the memory 708. At this time, data stored in the memory 708 is the command used for triggering the corresponding application program, so the operating system 706 can trigger the application program according to the command. In a word, in this example, the execution unit 208 is realized by the keypad controller 702 and the operating system 706. That is, the keypad controller 702 converts the touch signal into a readable command data for the operating system 706, and thereby the operating system 706 can trigger the corresponding application program. In the present invention, the command data is not limited to a certain type, and can be a scan code widespread used for the computer industry. Moreover, the scan code can be a special code defined by the manufacturer, or a signal and data which can be identified by a system. In addition, the computer system may transmit the signal through a bus, chipset, etc, which is well-know for those skilled in the art, so the detail is omitted herein.

### Example B

Unlike Example A, the keypad controller 702 does not convert the touch signal when the system is operated in the quick start mode, whereas the operating system 706 triggers a program desired to be executed for the user according to the data stored by the keypad controller 702. That is, the touch pad 700 is divided into a plurality of areas each corresponding to an application program when the system is operated in the quick start mode. If the user touches one of the plurality of areas, the touch pad 700 transmits the corresponding touch signal to the keypad controller 702. Since the keypad controller 702 does not convert the touch signal into the command data, the touch signal is stored in the memory 708. The keypad controller 702 outputs an interrupt signal to the central processor 704 for notifying the processor 704 of a touch event, and then the processor 704 notifies the operating system 706 to read the data stored in the memory 708. Meanwhile, the operating system 706 determines which area the user touches according to the data of the touch signal, so as to trigger the corresponding application program. Briefly speaking, in this example, the execution unit 208 is realized by the operating system 706, namely the operating system 706 triggers the corresponding application program according to a position of the touch signal.

Except to the abovementioned method, the execution unit 208 can be realized by an independent program. For example, FIG. 7B is a functional block diagram of a computer system 72, which is similar to the computer system 70 of FIG. 7A, but an intermediate program 710 is added in. For detailed description, please refer to the following examples.

### Example C

Similar to Example A, when the system is operated in the quick start mode, the touch pad 700 is divided into a plurality of areas each corresponding to an application program. If the user touches one of the plurality of areas, the touch pad 700 transmits the corresponding touch signal to the keypad controller 702, and then the keypad controller 702 can generate the corresponding command data according to the area of the touch signal, and store the command data in the memory 708. After that, the keypad controller 702 outputs an interrupt signal to notify the central processor 704 of a touch event. The central processor 704 then notifies the operating system to read data stored in the memory 708. At this time, data stored in the memory 708 is the command used for triggering a particular application program. After the operating system 706 reads the command data stored in the memory 708, the operating system 706 transmits the command data to the intermediate program 710 to trigger the corresponding application program.

### Example D

Similar to Example B, when the system is operated in the quick start mode, the touch pad 700 is divided in to a plurality of areas each corresponding to an application program. If the user touches one of the plurality of areas, the touch pad 700 transmits the corresponding touch signal to the keypad controller 702. The keypad controller 702 does not convert the touch signal into the command data, but stores the touch signal in the memory 708. After that, the keypad controller 702 outputs an interrupt signal to notify the central processor 704 of a touch event. The central processor 704 then notifies the operating system 706 to read data stored in the memory 708. Meanwhile, the operating system 706 determines which area the user touches according to data of the touch signal, and then notifies the intermediate program 710 to trigger the corresponding application program.

### Example E

Unlike Example D, when the system is operated in the quick start mode, the operating system 706 dose not determine which area the user touches, but transmits the touch signal to the intermediate program 710. The intermediate program 710 determines which area the user touches, and triggers the corresponding application program accordingly.

In the prior art, the touch pad uses the operating method of the mouse to control the computer system, so the user needs to execute complicated steps for triggering a desired program. In comparison, in the present invention, the user can enter the quick start mode through bottom pressing, software executing, etc, or can automatically enter the quick start mode after the computer system is booted. Therefore, the user can trigger the corresponding program by touching the touch pad, to enhance the utilization convenience. In addition, although the present invention takes the keypad controller, central processor, operating system, etc for implementing the method, in practical, the steps are not limited to be executed by any of components.

In conclusion, the present invention corresponds each area of the touch pad to a program, and if an area is touched, triggers the corresponding program. Therefore, through the present invention, the user does not have to enter the menu layer by layer, and can trigger the corresponding program by touching a certain area of the touch pad for enhancing the utilization convenience.

Those skilled in the art will readily observe that numerous modifications and alterations of the device and method may be made while retaining the teachings of the invention.

What is claimed is:

1. A method for controlling a computer system comprising a touch device for detecting a touch action and outputting a touch signal, a control module for receiving the touch signal, a display device, and an operation module for performing programs, wherein the touch device comprises a main touch area without display function, a touch point is moved for moving a cursor displayed in the display device, and the main touch area comprises a first partition and a second partition, the method comprising the following steps:
the control module receiving an enable signal;
a first touch point of the main touch area being touched;
the touch device outputting a first touch signal to the control module;
the control module deciding whether the first touch point is inside the first partition according to the first touch signal; and
the control module notifying the operation module to perform a first program if the first touch point is inside the first partition.

2. The method of claim 1, wherein the control module comprises a quick start program code, the control module performs the quick start program code after the enable signal is received, and decides which partition the first touch point is inside after the first touch signal is received.

3. The method of claim 2, wherein the control module comprises a common program code, the control module disables the quick start program code and performs the common program code after a disable signal is received, and calculates a displacement of the touch point after the touch signal is received, for moving a cursor displayed in the display device.

4. The method of claim 3, wherein the control module decides the first touch point is inside the second partition, and generates the disable signal.

5. The method of claim 3, wherein the control module generates the disable signal after the operation module is notified to perform a first program.

6. The method of claim 2, wherein the control module comprises a common program code, the control module determines whether a displacement of the touch point is greater than a predetermined value before the operation module is notified to perform the first program, and generates a disable signal when the displacement of the touch point is decided to be greater than the predetermined value, the control module disables the quick start program code and performs the common program code after the disable signal is received, and moves a cursor displayed in the display device according to the displacement of the touch point.

7. The method of claim 2, wherein the control module displays a user interface comprising information of the first program corresponding to the first partition in the display device after the enable signal is received.

8. The method of claim 1, wherein the control module displays a user interface comprising information of the first program corresponding to the first partition in the display device after the enable signal is received.

9. The method of claim 8, wherein the user interface displays relative position of the first partition and the main touch area.

10. The method of claim 9, wherein the touch device comprises a first visual indicator for indicating a position of the first partition.

11. The method of claim 1 further comprising the following steps:
the control module deciding the first touch point is inside the second partition, and corresponding the first partition to a third program;
the second touch point of the main touch area being touched;
the touch device outputting a second touch signal to the control module;
the control module deciding whether the second touch point is inside the first partition according to the second touch signal; and
the control module notifying the operation module to perform the third program if the first touch point is inside the first partition.

12. The method of claim 11, wherein the control module displays a user interface comprising information of the third program corresponding to the first partition in the display device after the first touch point is decided to be inside the second partition.

13. A method for controlling a computer system comprising a pointing device for detecting a direction action and outputting a direction signal, a control module for receiving the direction signal, a display device and an operation module for performing programs, wherein the control module moves a cursor displayed in the display device according to the direction signal, and the pointing device is capable of detecting areas of a first direction area and a second direction area, the method comprising the following steps:
the control module receiving an enable signal;
the pointing device detecting a first direction action;
the pointing device outputting a first direction signal to the control module;
the control module deciding whether the first direction action is inside the first direction area according to the first direction signal; and
the control module notifying the operation module to perform a first program if the first direction area is inside the first direction area.

14. The method of claim 13, wherein the control module displays a user interface comprising information of the first program corresponding to the first direction area in the display device after the enable signal is received.

15. The method of claim 14, wherein the user interface displays relative direction of the first direction area and the pointing device.

16. The method of claim 14, wherein the control module comprises a quick start program code, the control module performs the quick start program code after the enable signal is received, and decides which direction area the first direction action is inside after the first direction signal is received.

17. A computer system comprising:
a display device;
a touch device for detecting a touch action and outputting a touch signal, the touch device comprising a main touch area without display function, wherein a touch point is moved for moving a cursor displayed in the display device, and the main touch area comprises a first partition and a second partition;
a control module for receiving the touch signal, the control module being switched between a common mode and a quick start mode, wherein in the common mode, the control module calculates a displacement data of the touch point after the touch signal is received, and thereby controls the movement of the cursor according to the displacement data; and
an operation module for performing programs;
wherein the control module is switched to the quick start mode after an enable signal is received, the touch device detects a first touch point of the main touch area being touched, and outputs a first touch signal to the control module, the control module decides which partition the first touch point occurs according to the first touch signal, and notifies the operation module to perform a first program if the first touch point is inside the first partition.

18. The computer system of claim 17, wherein the control module comprises a quick start program code, the control module performs the quick start program code to enter the quick start mode after the enable signal is received, and decides which partition the first touch point is inside after the first touch signal is received.

19. The computer system of claim 18, wherein the control module comprises a common program code, the control module disables the quick start program code after a disable signal is received, performs the common program code to enter the common mode, and calculates a displacement of the touch point after the touch signal is received, for moving a cursor displayed in the display device.

20. The computer system of claim 19, wherein the control module decides the first touch point is inside the second partition, and generates the disable signal.

21. The computer system d of claim 19, wherein the control module generates the disable signal after the operation module is notified to perform a first program.

22. The computer system of claim 18, wherein the control module comprises a common program code, the control module determines whether a displacement of the touch point is greater than a predetermined value before the operation module is notified to perform the first program, and generates a disable signal when the displacement of the touch point is decided to be greater than the predetermined value, the control module disables the quick start program code and performs the common program code after the disable signal is received, and moves a cursor displayed in the display device according to the displacement of the touch point.

23. The computer system of claim 18, wherein the control module displays a user interface comprising information of the first program corresponding to the first partition in the display device after the enable signal is received.

24. The computer system of claim 17, wherein the control module displays a user interface comprising information of the first program corresponding to the first partition in the display device after the enable signal is received.

25. The computer system of claim 24, wherein the user interface displays relative position of the first partition and the main touch area.

26. The computer system of claim 25, wherein the touch device comprises a first visual indicator for indicating a position of the first partition.

27. The computer system of claim 17 further comprising:
the control module deciding the first touch point is inside the second partition, and corresponding the first partition to a third program;
the second touch point of the main touch area being touched;
the touch device outputting a second touch signal to the control module;
the control module deciding whether the second touch point is inside the first partition according to the second touch signal; and
the control module notifying the operation module to perform the third program if the first touch point is inside the first partition.

28. The computer system of claim 27, wherein the control module displays a user interface comprising information of the third program corresponding to the first partition in the display device after the first touch point is decided to be inside the second partition.

29. A computer system comprising a pointing device for detecting a direction action and outputting a direction signal, a control module for receiving the direction signal, a display device and an operation module for performing programs, wherein the control module moves a cursor displayed in the display device according to the direction signal, and the pointing device is capable of detecting areas of a first direction area and a second direction area, the computer system comprising:
the control module receiving an enable signal;
the pointing device detecting a first direction action;
the pointing device outputting a first direction signal to the control module;
the control module deciding whether the first direction action is inside the first direction area according to the first direction signal; and
the control module notifying the operation module to perform a first program if the first direction area is inside the first direction area.

30. The computer system of claim 29, wherein the control module displays a user interface comprising information of the first program corresponding to the first direction area in the display device after the enable signal is received.

31. The computer system of claim 30, wherein the user interface displays relative direction of the first direction area and the pointing device.

32. The computer system of claim 30, wherein the control module comprises a quick start program code, the control module performs the quick start program code after the enable signal is received, and decides which direction area the first direction action is inside after the first direction signal is received.

33. A method for controlling a computer system comprising a touch pad, the method comprising:
corresponding a plurality of areas of the touch pad to a plurality of programs of the computer system according to an enable signal;
detecting a touch signal from the touch pad; and
triggering a program of the plurality of programs according to a position of the touch signal included in an area corresponding to the program.

34. The method of claim 33, wherein the step of corresponding the plurality of areas of the touch pad to the plurality of programs of the computer system according to the enable signal further comprises displaying a graphical interface in a screen of the computer system for indicating a corresponding relationship between the plurality of areas and the plurality of programs.

35. The method of claim 34 further comprising stopping corresponding the plurality of areas of the touch pad to the plurality of programs of the computer system according to a disable signal.

36. A computer system capable of instantly triggering programs, the computer system comprising:
an operation module for realizing functions of the computer system;
a touch pad; and
a control device, coupled to the operation module and the touch pad, comprising:
an activation unit for corresponding a plurality of areas of the touch pad to a plurality of programs of the operation module according to an enable signal; and
an execution unit for triggering a program of the plurality of programs according to a position of a touch signal included in an area corresponding to the program when the touch signal from the touch pad is detected.

37. The computer system of claim 36, wherein the activation unit is further used for displaying a graphical interface in a screen of the computer system according to the enable signal, for indicating a corresponding relationship between the plurality of areas and the plurality of programs.

38. The computer system of claim 37, wherein the activation unit is further used for stopping corresponding the plurality of areas of the touch pad to the plurality of programs of the computer system according to a disable signal.

39. The computer system of claim 37 further comprising a setting unit for setting the plurality of areas to corresponding to the plurality of programs.
